(19) United States
(12) Patent Application Publication
(10) Pub. No.: US 2026/0092159 A1
(43) Pub. Date: Apr. 2, 2026

(54) PROTECTIVE SILICONE COATING COMPOSITION WITH MICA

(71) Applicants: Dow Global Technologies LLC, Midland, MI (US); Dow Silicones Corporation, Midland, MI (US)

(72) Inventors: Yanhu Wei, Midland, MI (US); Peng-Fei Fu, Midland, MI (US); John Ell, Midland, MI (US); Jenafer M. Duley, Midland, MI (US); Yongfu Li, Midland, MI (US)

(21) Appl. No.: 19/115,018

(22) PCT Filed: Sep. 29, 2023
(86) PCT No.: PCT/US2023/075462

§ 371 Date: Mar. 25, 2025

Related U.S. Application Data
(60) Provisional application No. 63/414,046, filed on Oct. 7, 2022.
(60) Provisional application No. 63/442,202, filed on Jan. 31, 2023.

(51) Int. Cl. C08K 3/34; C08G 77/00; C08L 83/04; C09D 7/61; C09D 183/04

(52) U.S. Cl. CPC C08K 3/34; C08G 77/80; C08L 83/04; C09D 7/61; C09D 183/04; C08G 2150/00

(57) ABSTRACT

The present invention is a composition comprising a TR—(RMeSiO2/2)n copolymer and a mica, where each R is independently phenyl or methyl. The composition of the present invention is useful as a coating for a metal substrate, wherein the coating exhibits adhesion, uniformity, and crack-resistance when subjected to high temperatures for hundreds or even thousands of hours.

### BACKGROUND OF THE INVENTION

The present invention relates to a silicone coating composition, more particularly a composition that is resistant to cracking and dielectric degradation at high temperatures, and a method for preparing the composition. High temperature protective coatings and insulating materials to protect a variety of equipment and devices against extremely high temperatures. Heater elements for electric vehicles, exhaust systems for automotive engines, power plants, and top coatings for stoves, for example, all benefit from such protective coatings. In many applications, the coating layers must withstand temperatures exceeding 300° C. over several months without cracking or losing dielectric and insulating properties and must pass aggressive thermal shock tests over a broad temperature range.

High temperature resistance of silicones ostensibly makes them promising candidates as high temperature protective coatings and sealants; nevertheless, silicone rubbers are not resistant to cracking above 250° C. beyond 3 weeks. The combination of silicone and inorganic filler such as SiO₂, TiO₂, and Al₂O₃ provides a composition with long term high temperature resistance; however, coatings prepared from such compositions require aging at temperatures exceeding 500° C. to form ceramic-like coatings. At such extreme temperatures, the coatings are likely to crack and suffer thermal shock failure; moreover, electronic elements beneath the surface of the coating are vulnerable to damage. It would therefore be an advance in the field of high temperature protective coatings to develop a composition that provides a coating that is resistant to cracking, delamination, and thermal shock failure, while maintaining acceptable dielectric properties at temperatures exceeding 300° C. for an extended period.

### SUMMARY OF THE INVENTION

The present invention addresses a need in the art by providing, in one aspect, a composition comprising a T^{R}-(RMeSiO_{2/2})ₙ copolymer and a mica, wherein each R is independently methyl or phenyl and wherein the weight-to-weight ratio of the T^{R}-poly(RMeSiO_{2/2})ₙ copolymer to the mica is in the range of from 10:90 to 90:10, wherein n is in the range of from 20 to 800. The composition of the present invention is useful as a coating for a metal, ceramic, or plastic substrate, wherein the coating exhibits good adhesion, and crack-resistance when subjected to high temperatures for hundreds of hours.

### DETAILED DESCRIPTION OF THE INVENTION

The present invention is a composition comprising a T^{R}-(RMeSiO_{2/2})ₙ copolymer and a mica, where R is methyl or phenyl and wherein the weight-to-weight ratio of the T^{R}-(RMeSiO_{2/2})ₙ copolymer to the mica is in the range of from 10:90 to 90:10, wherein n is in the range of from 20 to 800.

As used herein, the term “T^{R}-(RMeSiO_{2/2})ₙ copolymer” refers to a copolymer of comprising T^{R} resin units and (RmeSiO_{2/2})ₙ units where each R is independently methyl or phenyl. “T^{R} resin” refers to a kinetically stable three-dimensional polymer having repeat units of R-SiO₃/2, R—SiO_{2/2}(OZ), and optionally R—SiO_{1/2}(OZ)₂, where a unit of R—SiO_{3/2} is represented by the following structure:

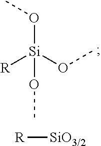

where the dotted lines represent the point of attachment to another silicon atom; a unit of R—SiO_{2/2}(OZ) is represented by the following structure:

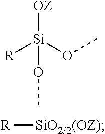

where Z is H, C₁-C₄-alkyl, or C(O)CH₃; and a unit of R—SiO_{1/2}(OZ)₂ is represented by the following structure:

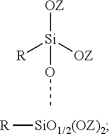

Each Z in the T^{R} resin is preferably H. A commercially available T^{Ph} resin is DOWSIL™ RSN-0217 Flake Resin and commercially available T^{Me} resins are DOWSIL™ RSN-2403 and DOWSIL™ RSN-2405 Flake Resins (A Trademark of The Dow Chemical Company or its Affiliates.)

The T^{R}-(RMeSiO_{2/2})ₙ copolymer contains units of a poly(dimethylsiloxane) (PDMS) or a poly(phenylmethylsiloxane) (PPhMS):

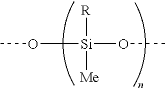

Where n is preferably from 20 or from 40 or from 70 or from 100, to 800 or to 500 or to 300 or to 200. The ratio of the T^{R} group to the (RMeSiO_{2/2})ₙ group is preferably in the range of from 30:70 to 70:30.

The T^{R}-(RMeSiO_{2/2}), copolymer may be prepared by first mixing in a suitable solvent and under reaction conditions a T^{R} resin, a silanol-terminated (RMeSiO_{2/2})ₙ and a crosslinking agent, wherein the crosslinking agent is preferably an acetoxylating or alkoxylating agent. Examples of suitable acetoxylating agents include alkyltriacetoxysilanes such as methyltriacetoxysilane and ethyltriacetoxysilane; suitable alkoxylating agents include phenyltrimethoxysilane, phenyltriethoxysilane, methyltrimethoxysilane, ethyltrimethoxysilane, methyltriethoxysilane, and ethyltriethoxysilane. A commercial example of an acetoxylating agent is XIAMETER™ OSF-1579 Silane (A Trademark of The Dow Chemical Company and its Affiliates), which is a 50:50 w/w blend of methyltriacetoxysilane and ethyltriacetoxysilane. Suitable solvents include aprotic solvents such as ethyl acetate, propyl acetate, propyl proprionate, and butyl acetate.

The acetoxy or alkoxy terminated (RMeSiO_{2/2})ₙ is then advantageously contacted with the T^{R} resin and additional solvent at an advanced temperature to partially or completely convert the T^{R} resin to a T^{R}-(RMeSiO_{2/2})ₙ copolymer, and to completely consume or nearly completely consume the acetoxy or alkoxy terminated (RMeSiO_{2/2})ₙ. Volatiles can be removed from the mixture to form a blend of copolymer and free T^{R} that can be used without further purification.

An example of a commercially available T^{Ph}-PDMS copolymer is DOWSIL™ 1-2577 Conformal Coating (A Trademark of The Dow Chemical Company or its Affiliates), which has a PDMS degree of polymerization (DP) of 40.

Micas are hydrated aluminum silicate minerals including muscovite, biotite, fuchsite, phlogopite, margarite, glauconite, and lepidolite micas, of which muscovite mica and phlogopite mica are predominant. The w/w ratio of the T^{R}-(RMeSiO_{2/2})ₙ copolymer to the mica is in the range of from 10:90 or from 20:80 or from 30:70, or from 40:60, to 90:10 or to 80:20 or to 70:30 or to 65:35.

In another aspect of the present invention, the composition comprises a T^{R}-(RMeSiO_{2/2})ₙ copolymer, a mica, and one or more the following components: a) T^{R} at a concentration in the range of from 1 or from 5 wt. % to 20 or to 30 wt. %, based on the weight of the composition; b) from 5 to 15 weight percent of a C₁-C₁₂-alkyl-tri-C₁-C₄-alkoxysilane; c) an aprotic solvent such as ethyl acetate, propyl acetate, butyl acetate, propyl propionate, and propylene glycol methyl ether acetate; and d) a moisture cure catalyst such as a tin-based catalyst such as tin octanoate or tin butanoate; or a titanium-based catalyst such as tetraisopropyl titanate, tetra-n-butyl titanate, and tetra-t-butoxy titanate.

The amount of aprotic solvent is sufficient to achieve a viscosity in the range of from 20 cP or from 50 cP or from 100 cP, to 20,000 cP or to 10,000 cP or to 5,000 cP, or to 1200 cP; alternatively, the concentration of aprotic solvent is in the range of from 5 or from 10 or from 20 weight percent, to 90 or to 75 or to 60 weight percent, based on the weight of the composition.

In yet another aspect of the present invention the composition comprises a T^{R}-(RMeSiO_{2/2})ₙ copolymer, a mica, a C₁-C₁₂-alkyl-tri-C₁-C₄-alkoxysilane, an aprotic solvent, and a moisture cure catalyst. The composition of the present invention provides a coating for a metal, ceramic, or plastic substrate that is tack-free and thermally stable to cracking for hundreds or even thousands of hours.

### Examples

DOWSIL™ 1-2577 Conformal Coating was used as Intermediate Example 1.

### Intermediate Example 2—Preparation of T^{Me}-PPhMS Copolymer with DP=50

A silanol terminated PPhMS (65 g, n=50), XIAMETER™ OSF-1579 Silane (OSF-1579, 5 g), and butyl acetate (50 g) were added under nitrogen to a 500-mL, 3-necked, dried flask equipped with a Dean-Stark apparatus. The temperature was increased to 50° C. and the mixture was stirred for 30 min. DOWSIL™ RSN-2403 Flake Resin (2403 resin, 35 g) and butyl acetate (60 g) were added to the reaction mixture, followed by heating to reflux for 1 h, during which time a mixture of acetic acid and H₂O (˜1.5 g) was collected at the bottom of Dean-Stark trap. Then, a portion of the solvent (˜60 g) was gradually removed to yield a solids content about 68 wt %. The reaction solution was cooled and directly used in the coating composition without filtration or further purification.

### Intermediate Example 3—Preparation of T^{Me}-PDMS Copolymer with DP=60

A silanol terminated PDMS (65 g, n=60), XIAMETER™ OSF-1579 Silane (OSF-1579, 5 g), and butyl acetate (50 g) were added under nitrogen to a 500-mL, 3-necked, dried flask equipped with a Dean-Stark apparatus. The temperature was increased to 50° C. and the mixture was stirred for 30 min. DOWSIL™ RSN-2403 Flake Resin (2403 resin, 35 g) and butyl acetate (60 g) were added to the reaction mixture, followed by heating to reflux for 1 h, during which time a mixture of acetic acid and H₂O (˜1.5 g) was collected at the bottom of Dean-Stark trap. Then, a portion of the solvent (˜60 g) was gradually removed to yield a solids content about 68 wt %. The reaction solution was cooled and directly used in the coating composition without filtration or further purification.

### Comparative Example 1 was Prepared by Combining Intermediate 1 with Tetraisopropyl Titanate (1 pbw)

### Examples 1-5—Preparation of Mixture of T^{Ph}-PDMS and Mica

C-4000 muscovite mica (K₂Al₄(Al₂Si₆O₂₀)(OH)₄, median particle size 10.8 μm, obtained from IMERYS) or MRX muscovite mica (median particle size 11.4 μm) or HRX phlogopite mica (K₂(Mg,Fe)₆(Al₂Si₆O₂₀)(OH,F)₄, median particle size 10.6 μm, obtained from Arctic Minerals) was dried in vacuo at 120° C. for 10 h, the cooled to room temperature under N₂. The dried mica was added to a vessel containing a mixture of T^{Ph}PDMS (DP=40, see Table 1), tetraisopropyl titanate (1 pbw), and butyl acetate at a sufficient amount to achieve a viscosity in the range of 500 to 2000 cPs, and the contents were mixed with a mechanical stirrer. The mixture was then stored under N₂.

### Comparative Example 2 was Prepared by Mixing Intermediate 2 with Tetraisopropyl Titanate (1 pbw)

### Example 6—Preparation of Mixture of T^{Me}-PPhMS and Mica

The dried mica (100 pbw) was added to a vessel containing (100 pbw), tetraisopropyl titanate (1 pbw), the T^{Me}-PPhMS copolymer (100 pbw, Intermediate 2), and butyl acetate (60 pbw). The contents of the vessel were mixed by mechanical stirring under N₂. The mixture was then poured into a bottle and sealed for further use.

### Comparative Example 3 was Prepared by Mixing Intermediate 3 with Tetraisopropyl Titanate (1 pbw)

### Example 7—Preparation of Mixture of T^{Me}-PDMS and Mica

The dried mica (100 pbw) was added to a vessel containing (100 pbw), tetraisopropyl titanate (1 pbw), the T^{Me}-PDMS copolymer (100 pbw, Intermediate 3), and butyl acetate (630 pbw). The contents of the vessel were mixed by mechanical stirring under N₂. The mixture was then poured into a bottle and sealed for further use.

### Long Term High Temperature Resistance Testing

Each sample was coated onto an aluminum panel at a coating thickness of 100 μm then heat cured and aged in an oven at 300° C. Film cracking time was recorded (in days) as the first instance of visible cracks in the coatings.

Table 1 shows the thermal stability of coatings as measured by crack time. A crack time of at least 10 d was considered a Pass. The wt % loading of mica is reported as 100 wt. % minus T^{Ph}-PDMS or 100 wt. % minus T^{Me}-PDMS or 100 wt. % minus T^{Me}-PPhMS.

TABLE 1
Thermal Stability of Coatings

| | T^{Ph}-PDMS | T^{Me}-PDMS | T^{Me}-PPhMS | | Crack time |
|---|---|---|---|---|---|
| Ex | (pbw) | (pbw) | (pbw) | Mica | (d) |
| C1 | 100 | | | none | 5 |
| C2 | | | 100 | none | 1 |
| C3 | | 100 | | none | 2 |
| 1 | 50 | | | muscovite | >100 |
| 2 | 60 | | | muscovite | >80 |
| 3 | 70 | | | muscovite | >67 |
| 4 | 70 | | | phlogopite | >39 |
| 5 | 80 | | | muscovite | 20 |
| 6 | | | 50 | muscovite | >50 |
| 7 | | 50 | | muscovite | >50 |

The data show a dramatic difference in resistance to cracking for coatings containing mica. The coating also exhibited acceptable uniformity and adhesion throughout the testing period. The combination of the T^{Ph} or T^{me} resin and mica alone was found to fail the cracking test within 2 d, while the combination of the PDMS or PPhMS and mica alone delaminated readily from the substrate at 300° C. Moreover, of the fillers tested—silica, calcium carbonate, aluminum silicate, calcium silicate, alumina, ferric oxide, and mica—mica was found to be the only class of fillers to exhibit crack times beyond 120 h.

### Example 8—Preparation of Room Temperature Tack-Free Coating

Methyltrimethoxysilane (10 parts by weight) and titanium tetra-t-butoxide (0.5 parts by weight) were added to the composition of Example 1. A sample of this composition was applied to an aluminum panel at a coating thickness of 100 μm. The coating became tack-free in 10 min at room temperature at a humidity of 50%. The coating was then subjected to heat age testing at 300° C. and was found to be crack free for >100 d.

1. A composition comprising a T^{R}-(RMeSiO_{2/2})ₙ copolymer and a mica, where each R is independently methyl or phenyl and wherein the weight-to-weight ratio of the T^{R}-(RMeSiO_{2/2})ₙ copolymer to the mica is in the range of from 10:90 to 90:10, wherein n is in the range of from 20 to 800.

2. The composition of claim 1 which further comprises a sufficient concentration of an aprotic solvent to achieve a composition viscosity in the range of from 20 cP to 10,000 cP.

3. The composition of claim 2 wherein the weight-to-weight ratio of T^{R} units to (RMeSiO_{2/2})ₙ units in the copolymer is in the range of from 30:70 to 70:30; and wherein the mica is muscovite or phlogopite; wherein the concentration of the aprotic solvent is sufficient to achieve a viscosity in the range of from 50 cP to 5,000 cP.

4. The composition of claim 3 wherein the weight-to-weight ratio of the T^{R}-(RMeSiO_{2/2})ₙ copolymer to the mica is in the range of from 20:80 to 80:20; wherein the concentration of the aprotic solvent is sufficient to achieve a viscosity in the range of from 100 cP to 1200 cP.

5. The composition of claim 4 wherein the weight-to-weight ratio of the T^{R}-(RMeSiO_{2/2})ₙ copolymer to the mica is in the range of from 30:70 to 70:30.

6. The composition of claim 5 wherein the weight-to-weight ratio of the T^{R}-(RMeSiO_{2/2})ₙ copolymer to the mica is in the range of from 40:60 to 60:40.

7. The composition of claim 1 wherein the mica is muscovite; and T^{R}-(RMeSiO_{2/2})ₙ is T^{Ph}-(dimethylSiO_{2/2})ₙ or T^{Me}-(dimethylSiO_{2/2})ₙ or T^{Me}-(phenylmethylSiO_{2/2})ₙ.

8. A composition comprising a T^{R}-(RMeSiO_{2/2})ₙ copolymer, a mica, an C₁-C₁₂-alkyl-tri-C₁-C₄-alkoxysilane based on the weight of the composition, an aprotic solvent and a moisture cure catalyst; wherein each R is independently methyl or phenyl; and wherein the weight-to-weight ratio of the T^{R}-PDMS copolymer to the mica is in the range of from 20:80 to 80:20; and wherein the concentration of the aprotic solvent is sufficient to achieve a viscosity in the range of from 50 cP to 5,000 cP.

9. The composition of claim 8 wherein T^{R}-(RMeSiO_{2/2})ₙ is T^{Ph}-(dimethylSiO_{2/2})ₙ or T^{Me}-(dimethylSiO_{2/2})ₙ or T^{Me}-(phenylmethylSiO_{2/2})ₙ, and the mica is muscovite mica.
